(19) United States
(12) Patent Application Publication
(10) Pub. No.: US 2003/0211224 A1
(43) Pub. Date: Nov. 13, 2003

(54) Squeezable peanut butter

(75) Inventors: Earl Carroll Eichelberger, Warwick, NY (US); Christopher Puno, Neshanic Station, NJ (US)

Correspondence Address: UNILEVER, PATENT DEPARTMENT, 45 RIVER ROAD, EDGEWATER, NJ, 07020, US

(73) Assignee: Unilever Bestfoods N.A.

(21) Appl. No.: 10/244,284

(22) Filed: Sep. 16, 2002

Related U.S. Application Data
(63) Continuation-in-part of application No. 10/142,452, filed on May 10, 2002.

(51) Int. Cl. A23L 1/38

(52) U.S. Cl. 426/633

(57) ABSTRACT

In a first embodiment, the invention is directed to an edible product comprising a squeezable nut butter in combination with a further edible component. The component is generally another food component which is desirably eaten with peanut butter, such as jelly, banana, marshmallow filling, chocolate, bacon bits, etc. Also, a squeezable edible product can advantageously be dispensed from a tube having an applicator cap with a dispensing orifice. Preferably the squeezable product is peanut butter, optionally in combination with a further food component such as jelly. The nut butter or other edible food is sufficiently flowable to be readily squeezable, yet is viscous enough such that its application can be easily controlled. It does not flow so freely so that its placement is beyond the control or the user.

This is a continuation-in-part of Ser. No. 10/142,452, filed May 10, 2002.

### BACKGROUND OF THE INVENTION

Peanut butter is widely enjoyed and finds a variety of uses. The most common use of peanut butter is in preparing sandwiches. Other uses include dipping and eating the peanut butter with edible carriers such as crackers or vegetable pieces. To a lesser degree, peanut butter is used in a variety of baking and cooking applications. Product characteristics which are responsible for peanut butter's wide acceptance and popularity are its flavor, its good nutritional properties and its suitability for consumption alone or in combination with a variety of other foods.

Since common uses of peanut butter call for spreading, it is paramount that the product be of a soft consistency and be easily spreadable to avoid tearing bread or crumbling crackers. Additionally, since children are the largest group of peanut butter users, a soft and spreadable product will help to facilitate the application of peanut butter to bread, crackers and the like by this group without the need for assistance from parents.

While peanut butter is much appreciated as a food, individuals assigned to clean eating utensils often feel differently. Peanut butter tends to adhere to knives, spoons and the like. Removal of peanut butter from those objects is a nuisance at best; any member found to have left peanut butter on a utensil during an after hours snack may well be ostracized within his household.

Conventional peanut butters utilize from 1.0 to 1.4 percent, and sometimes more, of a high melting (145°-155° F.) vegetable oil stabilizer primarily to reduce liquid oil separation. Somewhat higher levels of a lower melting point hardened vegetable oil stabilizer may also be used. Prior art disclosures of aerated peanut butters have utilized higher levels of high melting vegetable oil stabilizer above and beyond that required to prevent oil separation. These disclosures reveal such usage levels of 2 to 10% of a partially hydrogenated vegetable oil stabilizer to not only control oil separation but to stabilize the aerated product matrix.

It is quite apparent to those having even limited familiarity with peanut butter that use of a 2 to 10 percent level of high melting vegetable oil stabilizers, disclosed previously, will negatively affect the melt-down characteristic of a whipped product making it waxy and gummy along with reducing its spreadability. Such technical approaches, in essence, negate the very benefits of improved mouth-feel and spreadability sought through the use of aeration of conventional peanut butter or like products.

Much of the peanut butter literature focuses on achieving good spreadability and mouth feel, and on avoiding oil separation (syneresis). Particle size and viscosity are frequently discussed.

Traska et al., U.S. Pat. No. 5,202,147 is directed to a method of preparing a whipped peanut butter. Traska et al. mention that conventional peanut butters utilize from 1.0 to 1.4 percent of a high melting (145-155oF) vegetable oil stabilizer primarily to reduce liquid oil separation. They indicate that prior art disclosures of aerated peanut butters have utilized higher levels of high melting vegetable oil stabilizer above and beyond that required to prevent oil separation. The particle size of the inert gas cells is said to result in improved spreadability; gas cell particles in the range of 10 to 300 microns, especially 10 to 100 microns are believed to be used. The peanut butter of the Traska et al. invention may include high melting vegetable oil stabilizers preferably at from 1 to 5%, especially from 1.0 to 1.4%. Wong, U.S. Pat. No. 6,063,430 concerns peanut butter compositions comprising a blend of mono-modal and multi-modal compositions. The blended peanut butter is said to have a relatively low viscosity, yet avoid an oily appearance and greasy mouth feel. Wong indicates that as the viscosity and fineness of grind of a peanut butter is reduced to improve texture and spreadability, the visual appearance and mouthfeel of the butter become undesirably oily and greasy. The absence of particles of an appreciable size is said to result in a product having a greasy mouthfeel. Reducing the particle size of the nut solids is said to decrease their flavor impact.

Wong indicates that to reduce stickiness, the viscosity of the peanut butter needs to be reduced and that the viscosity is affected primarily by the particle size distribution of the nut solids. Peanut butters made by milling the nut solids to a mono-modal particle size distribution are said to have relatively lower viscosities. Wong also indicates that viscosity reduction can be achieved by increasing the amount of shear imparted to the nut paste to uniformly disperse particles with the oil and/or by increasing the level of added oil. High pressure or multiple pass homogenization is said to grind the nut solids to such a fine size that a significant portion of the peanut flavor volatiles originally present is lost.

The Wong invention is directed to the discovery that by blending a nut butter having a monomodal particle size distribution with a nut butter having a multi modal particle size distribution, the blended nut butter can have a creamy texture and good peanut flavor yet avoid an oily appearance and greasy mouthfeel. The Wong composition has a total solids particle size distribution of between about 22% and 34% between 16.7 and 87.1 microns. It is said that the compositions of the Wong invention can have an apparent viscosity of less than about 1500 cP, particularly less than 1000 cP, wherein the apparent viscosity is measured at a shear rate of 6.8 sec⁻¹. To minimize grittiness, water soluble solids preferably have a mean particle size of about 20 microns or less, especially about 10 microns or less. Stabilizers can be used at up to about 5%, preferably from about 1 to about 3%. Particle size distribution curves are given.

Wong et al., U.S. Pat. No. 5,079,027 discloses a nut butter spread composition having a Casson plastic viscosity of less than 12 poise. Preferably the peanut butter has a reduced fat content. At least about 80% of the nut solids have a particle size of less than 18 microns, most preferably 90% have a particle size less than 13 microns. Stabilizers are said usually to be added at from 0.5% to 3% by weight. Then-current peanut butter products are said to show a particle size distribution with one distribution curve in the range of from about 18 to about 118 microns and the other between about 3 microns and about 14 microns. In Wong et al, up to about 3%, preferably from 1% to 3%, stabilizer or emulsifier is used. Wong et al. indicate that in their invention less stabilizer is required. Oil separation is said to be reduced significantly. The lower fat level and much smaller peanut particle size produces a much slower settling rate and less oil separation. It is said that these peanut butters can be dispensed in a tube without oil separation.

Fix et al., U.S. Pat. No. 5,714,193 is directed to peanut butter spreads having a low viscosity of 2000 centipoise or less yet maintain desired nut flavor intensity. The spreads are obtained by high shear mixing of nut paste plus oil. Fix et al. disclose a nut butter said to have a viscosity of about 2000 centipoise or less, measured at 6.8 sec⁻¹, most preferably, about 1500 centipoise or less. After high shear mixing, the nut paste is passed through a deaerator. The nut spreads can be monomodal (more creamy, less sticky) or bimodal. The spreads have a Casson yield value of less than about 50 dynes/cm², preferably less than about 30 dynes/cm². In example 1, a mixture having an apparent viscosity of less than 1500 centipoise, and solids having a mean particle size of 10.5 microns is obtained for a composition having approximately 90% peanut materials.

Meade, U.S. Pat. No. 6,010,737 is directed to a reduced fat and reduced calorie nut butter composition. The composition is said not to have a high viscosity. The distribution of non fat solids in the finished peanut butter product are in the range of about 95% minimum less than or equal to 65 microns, about 75% minimum less than or equal to 25 microns, about 60% minimum greater than or equal to 6 microns. The mean particle diameter is preferably about 14-16 microns. A stabilizer is generally employed at from 0.5 to 3.5%, preferably 0.5-2%. The in-process Brookfield apparent viscosity of the peanut butter is about 6,000-50,000 centipoise, preferably 7,000-9000 centipoise. In Example 1, the peanut butter had a soft, spreadable texture.

Friedmann, U.S. Pat. No. 4,841,850 is directed to an apparatus and a process for processing biological raw materials into a creamy-like substance. The process includes the steps of supplying raw material to a container, displacing raw material from the collector to a de-aeration stage, eliminating air from the raw material in the de-aeration stage, allowing excess raw material to pass back from the de-aeration stage into the collector, and supplying de-aerated raw material from the de-aeration stage to a high pressure stage. The de-aerated material may be homogenized in the high pressure stage.

Japikse et al. U.S. Pat. No. 4,288,378 is directed to a peanut butter stabilizer.

An article entitled “RESERVISTS BRING THEIR BOSSES ALONG ON TRAINING; CIVILIANS RIDE HUMMERS AND HELICOPTERS AND SNACK ON MRES” in the Nov. 4, 2001 issue of the St. Louis Dispatch describes someone squeezing peanut butter from a tube onto a cracker.

The Oct. 17, 2001 edition of the Straits Times (Singapore), an article with a headline entitled “Radios Being Dropped to woo Afghan Hearts” describes a drawing showing how tubes of peanut butter should be squeezed.

An article in the Congressional Quarterly DBA Governing Magazine dated September, 2001 accompanied by the headline: “A STICKY STATE OF AFFAIRS” mentions that California prisons pack plastic peanut butter and jelly “squeezes” in lunch bags for prisoners who have off-site job.

The Pantagraph of Aug. 12, 2001, in a headline entitled “Scout records events of national conference” mentions that in 1997, the Scouts had crackers, squeeze cheese, squeeze peanut butter, squeeze jelly, and trail mix.

CNN THE SPIN ROOM 22:30 of May 14, 2001 reported that a company called P.J.'s Squares, has sent to the White House a couple of cases of little plastic squeezey things, like you might get mustard in or mayonnaise, but these are full of peanut butter and jelly.

Newsletter Database (TM), Copyright 2001 Marketing Intelligence Service Ltd., Product Alert of Mar. 26, 2001 discloses “Squeezers,” available from Portion Pac, Inc., located in Mason, Ohio. The 2.12 oz. pouches of Peanut Butter & Concord Grape Jelly Combo and Peanut Butter & Strawberry Jam Combo are presented in boxes that state, “Nutritious and fun—Grab and go—Easy lunches—Hiking, biking, camping, sporting events—No cutlery needed.” Squeezers is said to be a registered trademark of Thermo Pac, Inc.

The West County Times of Sep. 10, 2000 in an article about scouts mentions lunching on crackers with squeezable peanut butter and jelly.

An article in The Washington Post on Aug. 30, 2000, p F01 entitled EYE ON THE AISLES; Jump for Jerky by Carole Sugarman mentions that “last September” a Los Angeles company named Visionary Brands rolled out Peanut Squeeze—peanut butter in an easy-to-squirt plastic bottle.

Spreader applicator caps have previously been used for bottles of jelly.

The Enertia Trail Foods catalogue on the Internet at least as early as Sep. 16, 2002 shows a “Peanut Butter Squeezers” product in a mayonnaise-type pouch. On page 11, a “Peanut Butter/Jelly Combo Squeezers” product is mentioned.

Despite all of the attention which has been directed to peanut butter products, there is still a need for peanut butter products which are neatly and easily applied. There is further a need for readily applied peanut butter products admixed with other desirable edible components, such as jelly.

### SUMMARY OF THE INVENTION

The present invention takes several forms. In a first embodiment, the invention is directed to an edible product comprising a squeezable nut butter in admixture with a further edible component. The component is generally another food component which is desirably eaten with peanut butter, such as a filling or a particulate. The further edible component may, for example, add solids, texture and/or flavor. Examples of further edible components include jelly, banana, marshmallow filling, chocolate, bacon bits, etc. The invention is also directed to processes of making the edible product.

The present invention is also directed to the discovery that a squeezable edible product can advantageously be dispensed from a tube having an applicator cap with a dispensing orifice. Preferably the squeezable product is peanut butter, optionally in combination with, e.g., admixed with, a further food component such as jelly. While the nut butter or other edible squeezable product of the invention is readily squeezable from a container such as a tube or a squeeze bottle, thereby permitting very convenient application of the product onto bread or another vehicle for ingestion of the nut butter, etc., use of a tube in particular facilitates squeezing of the product and evacuation from the container. Moreover, spreading of the nut butter using a tube or other squeeze container minimizes or eliminates the need to soil utensils with peanut butter or to use throw-away knives, spoons and the like. In accordance with the invention, the nut butter or other edible food is sufficiently flowable to be readily squeezable, yet is viscous enough such that its application can be easily controlled. It does not flow so freely so that its placement is beyond the control of the user.

Where a squeezable nut butter is employed in any of the forms of the invention, preferably the product of the invention is a peanut butter as defined in 21 CFR (Apr. 1, 2000 edition) Section 164.150, namely it contains ground shelled and roasted peanut ingredients of at least 90 wt. % and a maximum fat content for the finished food of not greater than 55% when determined as prescribed in “Official Methods of Analysts of the Association of Official Analytical Chemists,” 13^{th} edition, (1980) section 27.006(a) under “Crude Fat-Official First Action, Direct Method.” The peanut ingredients may be blanched peanuts in which the germ may or may not be included, and unblanched peanuts, including the skins and germ.

Desirably, the nut butter of the invention possesses one or more of certain characteristics which make it ideal for a squeezable peanut butter. Preferably the viscosity is neither so high that flow is impeded during squeezing, nor so low that the product flows uncontrollably. Moreover, the nut butter of the invention is stable against oil separation. The viscosity of the product of the invention as reflected in a yield stress is preferably at least 70 dyne/cm², more preferably at least 821 dyne/cm², up through 7250 dyne/cm².

Another advantageous feature of the nut butter which can be used in the invention, reflective of controllable squeezability, is the squeeze force, measured by the squeezing flow rheological technique discussed below. Nut butters of the invention preferably have a squeeze force (in kg) of from 1.6, preferably 1.9 up to and including 3.2. Preferably nut butters combined with further food components such as fillings also have a squeeze force (in kg) of from 1.6, preferably 1.9 up to and including 3.2. Other squeezable edible products according to the invention generally have a squeeze force (in kg) of from 0, especially from 0.5, up to and including 3.9, measured at 25° C. Preferably also the combined squeezable edible product and further food component also has a squeeze force (in kg) of from 0, especially from 0.5, up to and including 3.9, measured at 25oC.

The nut butters used in the invention preferably include stabilizer, but in limited amounts. Levels of from 0.25 wt. %, more preferably from 0.5 wt. % through 1.25 wt. % are preferred. The stabilizer is preferably a fully or partially hydrogenated vegetable oil. The inclusion of modest amounts of stabilizer facilitates formulation of a nut butter which is squeezable and has good mouth feel but does not flow uncontrollably.

For a more complete understanding of the above and other features and advantages of the invention, reference should be made to the following detailed description of preferred embodiments and to the accompanying drawings.

### BRIEF DESCRIPTION OF THE DRAWINGS

FIG. 1 is a diagram of a process for making the product of the invention using a double milling procedure.

FIG. 2 is a schematic diagram of a set of parallel plate for measurement of squeezing flow.

FIG. 3 is a front elevational view of a tube with an applicator cap suitable for use in the present invention.

FIG. 4 is a top plan view of an applicator cap atop a container neck (container tube not shown) which may be used in accordance with the invention.

FIG. 5 is a front elevational view of an applicator cap which may be used in accordance with the invention.

FIG. 6 is a front elevational view of the neck of a container tube to which the applicator cap may be fastened.

FIG. 7 is a cross section along the lines 7-7 of FIG. 4.

FIG. 8 is a cross section along the lines 8-8 of FIG. 4.

FIG. 9 is a top plan view of the cap of FIG. 7, with the closure in the opened position, showing only the shape of the product egress orifice.

### DETAILED DESCRIPTION OF THE INVENTION

The squeezable peanut or other nut butter which may be used in the invention may include high melting vegetable oil stabilizers of palm, cottonseed and similar vegetable oil origins at a level of from 0.5 to 10 percent, preferably from 1 to 5%. It is especially preferred that the high melting (145°-155° F.) vegetable oil stabilizer levels, especially of palm, cottonseed and similar vegetable oil origins, be from 0.25 to 1.75 percent, especially from 0.5 to 1.25%, i.e., in a somewhat lower range of stabilizer usage than found in today's market. The stabilizer tends to reduce liquid oil separation and to improve the viscosity of the product.

The preferred compositions of this invention fully comply with the FDA standard of identity for peanut butter. These require that the standardized product contain a minimum of 90 percent ground roasted peanuts and no more than 10 percent of optional seasoning and stabilizing ingredients such as salt, nutritive sweeteners and hydrogenated vegetable oils and emulsifiers such as mono- and diglycerides. The percent by weight of peanuts can range from 90 to 95% and higher for standard peanut butters.

Appropriate seasonings and stabilizing ingredients include the following and combinations thereof; salt, sugar, liquid sugar, dextrose, honey, fructose, corn syrup, medium invert and invert sugars, maple syrup, molasses, liquid or powder, peanut oil, particularly high flavor oil extracted from roasted peanuts, vegetable oils, fractionated vegetable oils and partially hydrogenated vegetable oils, including soybean, palm, coconut, cottonseed, corn, rapeseed, canola and peanut oils, saturated and unsaturated mono- and diglycerides and lecithin, polyglycerol esters and other food emulsifiers. It is preferred that the seasonings and stabilizing ingredients added to the peanuts do not exceed the 10% limit imposed by the Standards of Identity for peanut butter. In particular, the seasonings and stabilizers preferably constitute from 0.5 to 10%.

If needed, liquid molasses or dried powdered molasses may be added to improve the color of the final product. A suitable powdered molasses is MC-71, which is granulated so that 90% will pass though #100 U.S. standard sieve, supplied by Sethness Co., Chicago, Ill. 60647.

The mixture of peanuts, seasonings and stabilizers is ground into a fine paste for example via the use of milling equipment which is standard in the peanut butter industry, such as a Bauer and/or an Urshel mill. The milled peanut butter paste may be collected in a standard feed or supply tank fitted with a vacuum system to de-aerate the milled paste from any entrapped or entrained atmospheric air. It may also be de-aerated prior to milling.

Generally, the composition of the invention will include peanut oil. Optionally as supplement and to boost further the flavor intensity, a high flavor peanut oil may be used in accordance with this invention. The high flavor peanut oil is obtained by the extraction of oils from dark roasted peanut. As example of a high flavor peanut oil suitable for use herein is the high flavor peanut oil extracted from dark roasted peanuts supplied by Food Materials Corp., Chicago, Ill. 60618. The high flavored peanut oil may be added at levels of 0.5 to 3.0%. Also, dark roasted peanut paste may be used.

Squeezable edible products other than peanut butter may include squeezable margarine, butter and other bread spreads, jelly, cream cheese and other squeezable cheese products. Margarine, butter and other bread spreads may have fat levels ranging from a high of about 80 wt % or more to 60 wt. %, 40 wt. % and even down to zero % fat. Preferably at least 0.1 wt. % fat is included. In the lower fat spreads, other ingredients such as gelling agents may replace some or all of the fat.

In the case of peanut butter, the further edible components will generally be ingredients which are not within the Standard of Identity mentioned above. For peanut butter and other squeezable edible products, the further edible components which may be added to the nut or other butters or other products include jelly, chocolate, chocolate and/or bacon bits (provided the dimensions of the bits are sufficiently small to be dispensed through the aperture of any applicator cap which may be used), and marshmallow filling. The jelly may be any flavor, such as grape or strawberry jelly. An example of a suitable jelly is a grape filling available from Haarmann & Reimer. The ingredient statement for the Haarmann & Reimer grape filling is as follows:

Dextrose, Sugar, Corn Syrup, Water, Fructose, Glycerine, Modified Corn Starch, Grape Juice Concentrate, Natural Flavors, Apple Powder, Citric Acid, Salt, Soybean Lecithin, Propylene Glycol, Gellan Gum, Sodium Benzoate, Potassium Sorbate, Sodium Citrate, Red 40, Blue 1.

As indicated above, the further edible components will generally be fillings or particulates. Fillings can be defined as sweet or savory food mixtures used to fill pastry, cake or sandwiches. Examples of fillings/filling components include: fruit, chocolate, jams/jellies, apricot, cherry, blueberry, guava, lemon, mango, raspberry, strawberry, papaya, marshmallow and banana. Often fillings will include a gel material such as a pectin. Gum bases, such as guar, are common. The filling will generally be low in water and/or high in sugar. Fillings generally impart flavor/and or solids and/or texture to the food.

The further edible components may also be particulates, such as graham, puffed rice and chocolate morsels. Particulates may impart texture and/or flavor and/or solids to the food.

For some further edible components which may be mixed with the squeezable food component, e.g., nut butter, it is important to consider the water activities of the further edible component and the nut butter. For instance, to promote compatibility, a variegate, such as grape jelly, which is to be in direct contact with the peanut butter in a given packaging format has the following desirable characteristics:

The water activity must be at or below 0.62

The difference in water activity between the filling and the peanut butter must not be more than 0.3 units (to reduce osmotic pressure differences)

For squeezable food components in general, it is difficult to generalize what the water activity of the further edible component must be, since the water activities of the possible squeezable food components will be different. However, it is a good rule of thumb for all combinations of squeezable food component and further edible component that the difference in water activity between the further edible component and the squeezable food component must not be more than 0.3 units (to reduce osmotic pressure differences)

Appropriate selection of water activity can favorably impact shelf stability by minimizing microbiological growth and leaching of water between the components.

For longer term stability, the filling should:

Be a low pH (<4.5)

Contain mold inhibiting preservative (Potassium Sorbate or Benzoate)

The further edible components, e.g., filling, may be used at levels of, say, 15-50 wt. % of the combined squeezable food and filling. The further edible components may be combined in patterns wherein the squeezable edible component, e.g. peanut butter and the further edible component, e.g., jelly or other filling are mixed in discrete portions discernable to the consumer. For instance, the jelly or jam can be present in swirls. Striping is available, for example, on Norden tube filling machines available from Norden Pac Machinery AB of Sweden.

It is believed that improved dispensing is obtained by containing the product of the invention in a squeezable tube having an applicator cap with a dispensing orifice affixed thereto. The dispensing orifice will be not be coextensive with the circumference of the cap, i.e., it will be narrower. It can have various shapes, such as that of a running track (FIG. 9) or a circle. This can be expected to facilitate controlled dispensing of the squeezable product.

Preferred containers are Medium Density Polyethylene (MDPE) tubes, which may be obtained from CCL Plastic Packaging. It may include an EVOH copolymer barrier layer. While a plastic tube is preferred, it may also be metallic, e.g., tin, aluminum, etc. Preferably the tubes are flushed with nitrogen prior to filling to prevent/minimize oxidation and oil separation. A safety seal or other consumer protection device can be employed. The cap preferably has the design of the spreading-type, running track-shaped orifice, as seen in FIG. 9.

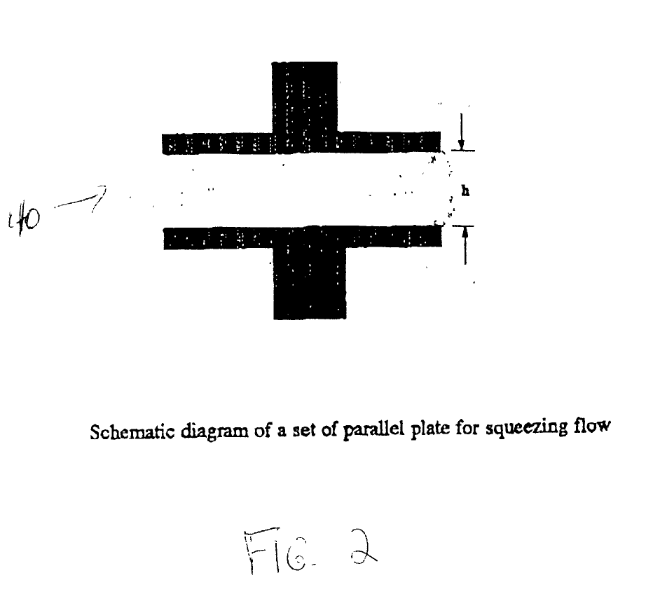

Preferred dispenser 100, seen in FIG. 3, includes tube portion 102 and cap portion 104. Container 100 is made from a polymeric web formed into a tube, and heat sealed at one end and longitudinally as is known In the art. Sealing is preferably effected by hot air welding (blowing hot air and crimping). Cap 104 comprises base 106 and removable closure 108. Closure 108 may be attached to base 106 as by a hinge (not shown). Indentation 114 in base 106 facilitates removal of closure 108.

Container neck 110 (FIG. 6) includes external threads 112 or other fasteners to facilitate attachment to cap base 106 via its internal threads 109. Orifice 116 is preferably shaped to facilitate dispensing of the product. For example, it may take the shape shown in FIG. 9. Unlike standard tubes used for ingestable materials, the internal diameter 111 of tube neck 110 is preferably large so that the squeezable food can be readily squeezed through the tube neck and orifice 116. For example, the internal diameter of the tube neck may be from 0.8 to 1.3 inches, especially from 1 to 1.3 inches. Orifice 116 is preferably elongated or slot-like as in the illustrated running track shape. Preferably the length of the orifice ranges from ⅜ inch to ⅞ inch, especially from 1/2 to ¾ inch. The height of the opening (thickness of the product squeezed from the container) is from 0.1 inches to 0.25 inches. Preferably the opening does not exceed 0.25 inches in height at any point.

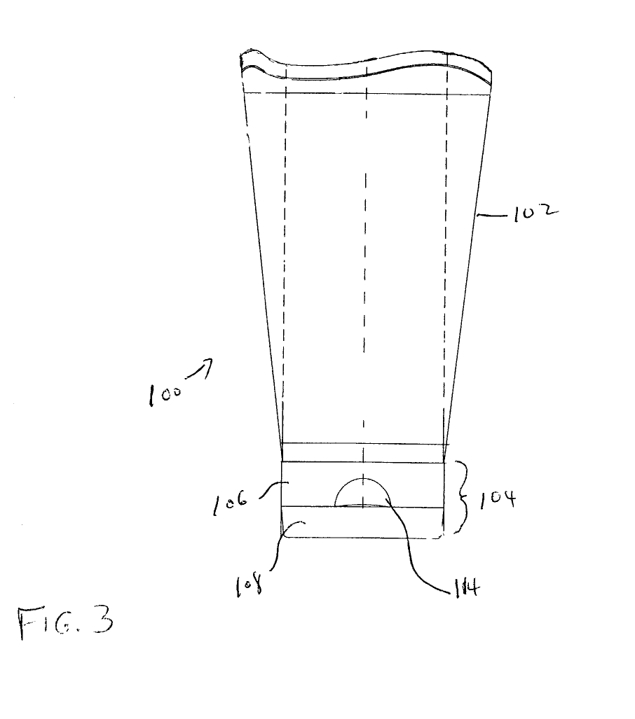

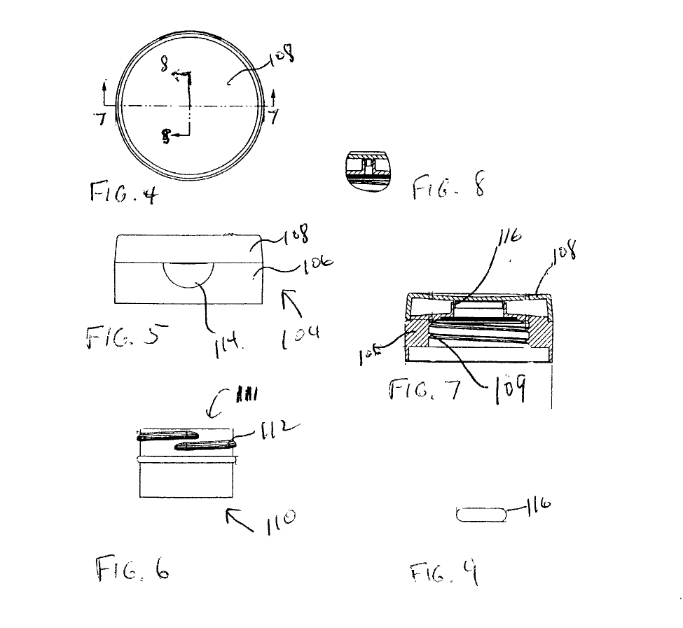

The consumer dispenses the product by opening closure 108 and squeezing the tube 102 of container 100. Use of the spreader cap illustrated in FIGS. 4, 5 and 7-9 permits consumers to spread the peanut butter or other squeezable edible material without requiring a knife or other utensil.

The following procedure may be used to fill the tubes, with a squeezable peanut butter used for illustration (Procedure A):

1. Squeezable peanut butter formulation is made (as described below). Filling spout is connected to the main product input of a variegator unit (TD Sawvel).

2. The filling is poured into a hopper/pump and connected to the variegate input of the variegator.

3. Both product are fed into the variegator unit at the appropriate levels (pump settings for each component controls the amount of each being fed into the variegator)

4. Motor setting on the variegator unit is set so the proper swirl is being obtained

5. The variegated product is sent to the hopper of the Tube filling operation [Nordenmatic 700 Filler]

6. MDPE tubes are filled with the variegated peanut butter

Other methods for making a variegated peanut butter involve:

Multiple Filler Heads on the Norden Tube filler

Injection of the filling directly into the peanut butter

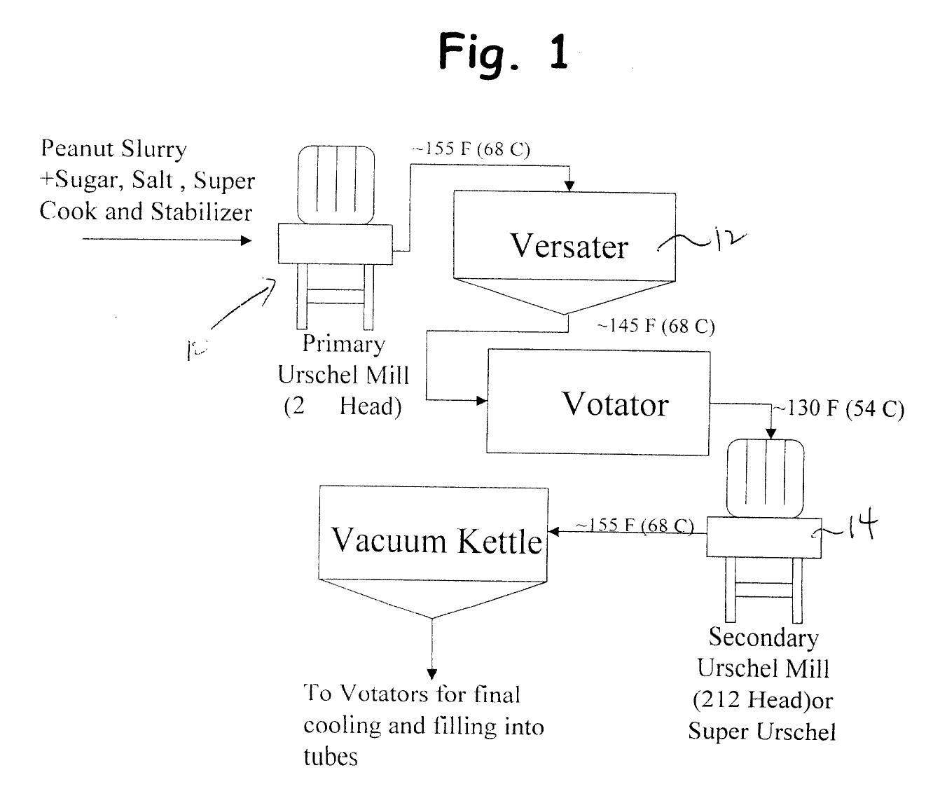

The squeezable food products of the invention, e.g. a nut butter, may be prepared using the following procedure (the Preparation Procedure), which is illustrated in FIG. 1.:

a) ground roasted full fat nuts are heated to a temperature above the melting point of the given stabilizer, for example to 145° F., especially 155-160° F. or above.

b) the ingredients are added to the heated slurry in accordance with the formulation and thoroughly mixed.

c) the peanut mixture is cooled to 125° F. and then fed into the primary milling operation Urschel Mill 10 at a rate to ensure particle size distribution of 90%<=40 microns, ⁵⁰%<=13 microns and 10%<=3 microns with a mean diameter of 15-20 microns. The mill is model MG 1700 having a 212 head. The mixture emerges from the Urschel Mill at 165-170° F.

d) the milled composition is deaerated using Versater 12 or vacuum kettle and cooled to approximately 130° F. in the Votator.

e) the deareated product is fed through the secondary milling operation Urschel Mill 14 at a rate to ensure monomodal particle size distribution of 90%<=35 microns, 50%<=12 microns and 10%<=2.5 microns with a mean diameter of 13-17 microns. The mixture emerges from the Urschel Mill at 165-170° F.

f) the milled composition is deaerated, cooled to 155-160° F. before filling and filled at 85-90° F. filled at 850 to 95° F. into tubes or squeezable bottles.

g) the resulting peanut butter is a soft squeezable product.

Alternative vacuuming and milling such as homogenizers, Colloid mills and Fryma mills are acceptable provided that the criteria in (e) have been obtained.

The following test methods may be used:

Method For Determining Relative Oil Separation Stability Of Creamy Style PNB

A weight of peanut butter is placed into a tared centrifuge tube and spun at 700 rpm for 2-hours. After the 2-hour centrifugation, any expressed oil is wicked off using an absorbent tissue and the resulting loss of oil determined by weight difference. The rate of oil expression is calculated by dividing the weight of expressed oil in grams by 2 (hours). The amount of oil expressed at a constant centrifugal force is directly related to the surface area of the peanut butter in the centrifuge tube. Faster or slower applied centrifugal force will increase or decrease oil expression rate. Preferred layer separation centrifuge rates for squeezable products range from 0.305 g oil/hour to 0.04 g oil/hour, all measured at 25oC.

Method of Yield Stress Determination Using “Vane”¹ This is a testing sensor containing 4 or 5 or 6 rectangular elements, attached to a center rod and equally spaced along circumferential direction. The end view is like a star-shape.

Introduction

Yield stress is defined as the minimum stress that is required to cause an otherwise solid-like material to flow. Most of the food materials such as peanut butter, mayonnaise, pourable dressings, or tomato paste have yield stresses. This is a critical rheological parameter because it relates to the strength of network. For example, yield stress of peanut butter is related to the strength of the crystal network that is developed during cooling of the peanut butter slurry.

Use of the vane for yield stress determination for food gels offers several advantages over conventional Theological technique to which a set of parallel plates or cone/plate or concentric cylinders is often adapted. First, insertion of the vane into peanut butter jar minimizes slippage, which often occurs on using conventional rheological techniques, between the test sensor and material. Secondly, test in the jar avoids sample preparation necessary on using conventional techniques to minimize unwanted shear history. Thirdly, presence of chunk particles in the product yields little flow interference on yield stress measurement, since the distance between the rim of the sensor and the wall is widely open.

Test Procedure

A vane test is carried out by gently introducing the vane sensor into a sample of the jar until the vane is fully immersed. The depth of the sample and the diameter of the jar should be at least twice as large as the length and diameter of the vane to minimize any effects caused by the rigid boundaries. The vane is rotated very slowly at a constant rotation speed 0.05 rad/s, and the torque required to maintain the constant motion of the vane is measured as a function of time (or angle of rotation). For materials having a yield stress, the trace of the torque versus time will pass a maximum. The yield stress is then determined from the maximum and the geometry of the vane.

Yield stress determination for peanut butter is carried out on Haake Rheometer using a six-element vane with a diameter of 2 cm and a length of 2 cm.

Use of a Rheological Technique-Squeezing Flow for Predicting Textural Spreadability of Peanut Butter

The present technique is based on a theory on obtaining shear viscosity as a function of shear rate using squeezing flow with a set of non-lubricated parallel plates such as plates 40 shown in FIG. 2. This method offers a unique opportunity to develop the viscosity of peanut butter covering 4 decades of shear rates from less than 10 to as much as 4000 sec⁻¹ or higher at room temperatures. This broad coverage is critical (i) to assess the degree of product spreadability, and (ii) to cover a shear rate range that corresponds to either spread of peanut butter on a bread or biting in the mouth.

A comparison in viscosity vs. shear rate for a full fat commercial peanut butter and a 25% RF peanut butter reveals that the commercial full fat is more shear thinning, suggesting that the full fat is more spreadable than its 25% RF counterparts. This is supported by sensory evaluation. In addition, a series of 25% reduced fat peanut butter samples were evaluated during gap mill start-up. Correlations were found between the data from squeezing flow and sensory response (see reference).

In contrast, commercial rotational rheometry (either Rheometrics or Haake) is incapable of providing such data higher than 10 sec⁻¹ without causing flow instability.

Textural devices (such as penetrometer or firmness device) do not always discriminate the differences among the products resulting from process or ingredient variation due to their poor sensitivity to the structural variation of the products.

Also the data on firmness or penetration are not always related to textural response in sensory determination. Coupled with varying jar size, the force in resistance or depth penetration can be influenced significantly by the presence of wall. This makes comparison of the products difficult. This is because the measurements are highly empirical and they do not represent true rheological behavior of the sample.

Theory

The principles of squeezing flow have long been established in the scientific community. It contains the two parallel plates as shown in FIG. 2. The flow pattern is determined by whether the plates are lubricated to minimize friction at interfaces or non-lubricated to induce shear at walls. In both cases, the tests are performed at a constant speed in axial direction and the force exerted on the plate is then recorded.

When a sample is placed between two plates, it is assumed that the sample will adhere to the walls while the test is being conducted. The force exerted on the plates as a function of test geometry and sample viscosity is given by Stefan's equation:

F(t)=(3/2)μR⁴v/h³(t) (1)

where R is the radius of the plate, h(t) is the gap which is a time dependent variable. μ is the viscosity, v is the speed of the plate, and F(t) is the force which again is a time dependent variable. Once the experimental data on force and gap at a constant speed is obtained, the viscosity as a function of shear rate at walls (at rim of the plate) can be determined using equation (1). The maximum shear rate γₘₐ ^{Y} at the walls and at the rim is determined as follows:

γₘₐₓ^{Y}=3^{Y}(t)R/h²(t) (2)

Experimental Conditions

Squeeze flow tests are conducted on a set of parallel plates with a top plate diameter of 1 inch at an axial speed 1 mm/s from 4 mm thick to 100 micron using textural analyzer. The data of force and gap at various times are recorded.

As the plate starts to squeeze the sample at a height of 4 mm at 1 mm/s, the force rises instantaneously. This initial response is related to the transient response of material at the start-up of squeezing flow. A more gradual increase of the force is noted following the transient response. The sets of data are computed using equations (1) and (2) to obtain viscosity as a function of shear rate. A comparison in viscosity vs. shear rate is plotted e.g., at a shear rate about 3 sec⁻¹.

Squeezing flow using a set of parallel plates generates viscosity as a function of shear rate for PNB gel at room temperatures. The calculated shear rate covers a range from less than 10 sec⁻¹ to as high as 4000 sec⁻¹. This wide shear rate coverage is absolute necessary to obtain rheological response that is close to that of the product evaluation: spread of peanut butter on a piece of bread or biting action in the mouth. In contrast, commercial rotary instruments cannot be operated to such higher shear regime without causing flow instability. Hence squeezing flow technique provides a very powerful means to obtain the high shear behavior of gel systems that the other instrument cannot do otherwise.

The spreadability of PNB gel is predictable from the results of squeeze flow. A Malvern Mastersizer 2000 particle size analyzer is used to analyze the particle size of the samples. A small amount (about 0.01 grams) of its sample was placed in a 25 ml test tube and about 15 ml of iso-octane are added to it. The sample is dispersed in the iso-octane by using a vortex mixer. A transfer pipette is then used to add this diluted solution dropwise to the iso-octane filled cell of the analyzer. The sample is added until the obscuration is 0.15 to 0.20. The obscuration refers to the amount of light which is obscured by the sample because of diffraction and absorption. The instrument reads more accurately when the obscuration is 0.05 to 0.5 and preferably from 0.15 to 0.20 (15% to 20% of the light energy is reduced). Each sample is swept 250 times by the laser for each reading.

### EXAMPLES

### Example 1

A peanut butter having the following ingredients is prepared.

| Ingredient | Level % |
|---|---|
| Peanut oil | 5.0 |
| Roasted peanuts | 86.3 |
| Stabilizer (hardened rapeseed oil | 1.0 |
| blended with cottonseed oil and | |
| hydrogenated soybean oil | |
| Sucrose | 6.2 |
| Salt | 1.5 |
| Total % | 100.000 |

The product is prepared (using the Preparation Procedure shown above) by milling under vacuum and then filling jars with the peanut butter.

### Example 2

The product of Example 1 is made, except that the amount of stabilizer is varied from 0.25 wt. % to 1.75 wt %. Various measurements are made, as seen in Tables 1-3.

TABLE 1

| | Particle Size | | | | |
|---|---|---|---|---|---|
| | | 90% | 50% | 10% | |
| PRODUCT | Mean Vol | Below | Below | Below | Span |
| 0.25% | 16.74 | 36.63 | 11.24 | 1.82 | 3.10 |
| 0.5% | 16.05 | 36.04 | 11.14 | 1.77 | 3.05 |
| 0.75% | 16.09 | 36.39 | 11.31 | 1.73 | 3.06 |
| 1.25% | 15.55 | 35.36 | 10.94 | 1.71 | 3.08 |
| 1.75% | 15.80 | 35.79 | 11.05 | 1.80 | 3.08 |

TABLE 2

| | Viscosity | | | | | Yield |
|---|---|---|---|---|---|---|
| Stablz | | | | Thixotropic | % | Stress |
| % | Yield | 10 1/s | 40 1/s | Area | Thixotropy | dy/cm\hat{ }2 |
| 0.25% | 200 | 8770 | 5005 | 4730 | 13.5 | 70 |
| 0.5% | 821 | 18244 | 6148 | 8354 | 20.4 | 1026 |
| 0.75% | 1320 | 26780 | 7400 | 11330 | 25.4 | 1565 |
| 1.0% | 2221 | 38473 | 7769 | 16360 | 33.7 | 3996 |
| 1.25% | 3090 | 49821 | 8695 | 21280 | 44.5 | 7250 |
| 1.75% | 4275 | 68520 | 9975 | 28100 | 51.4 | 12020 |

TABLE 3

| | |
|---|---|
| Layer Separation | |
| (centrifuge) | Squeeze |

| Stablz | Wt oil/ | Rate | Force |
|---|---|---|---|
| % | 15 g | g oil/hr. | (kg) |
| 0.25% | 1.117 | 0.558 | 1.601 |
| 0.5 | 0.611 | 0.305 | 1.94 |
| 0.75% | 0.34 | 0.170 | 2.243 |
| 1.0% | 0.164 | 0.082 | 2.701 |
| 1.25% | 0.087 | 0.043 | 3.111 |
| 1.75% | 0.022 | 0.011 | 3.848 |

### Example 3

Measurements are taken for several commercial peanut butter products and are set forth in Table 4.

TABLE 4

| | Particle Size | | | | | Yield Stress | Squeeze |
|---|---|---|---|---|---|---|---|
| PRODUCT | Mean Vol | 90% Below | 50% Below | 10% Below | Span | dy/cm\hat{ }2 | force (kg) |
| Commercial 1 | 20.16 | 42.54 | 12.75 | 2.09 | 3.17 | 11550 | 4.726 |
| Commercial 2 | 19.12 | 40.38 | 12.60 | 2.07 | 3.08 | 13660 | 4.177-4.650 |
| Commercial 3 | 20.38 | 41.5 | 12.27 | 1.97 | 3.22 | 9300 | 4.650 |

None of the commercial products includes the preferred yield stress or squeeze force of the present invention, which is related to the optimal squeezability of the present product.

Squeezing flow as used herein for predicting spreadability of PNB Products according to the invention at all levels of stabilizer yield significantly lower squeeze force relative to two commercial regular full fat PNB. This indicates that the viscosity of the squeezable spread is significantly lower and hence more spreadable relative to commercial regular full fat PNB.

### Example 4

The peanut butter of Example 1 is combined with 35 wt. % grape jelly in a tube having an applicator cap, as illustrated in FIGS. 3-9, using Procedure A above. A peanut butter having visible grape jelly and which is controllably squeezable through the spreader orifice of the applicator cap is obtained.

What is claimed is:

1. An edible product comprising a squeezable nut butter having
a) at least 60% of its particles having its largest diameter of from 14-17 microns,
b) a yield stress of from 1026 to 3996 at 25° C.,
c) a stabilizer level of from 0.5 to 1.5 wt. %, and
d) at least 90 wt. % nut materials, in combination with a further edible component.

2. The edible product according to claim 1 wherein said further edible component is selected from the group consisting of jelly, banana, and marshmallow filling.

3. The edible product according to claim 2 wherein said jelly includes a grape jelly or a strawberry jelly and said nut butter comprises peanut butter.

4. An edible product comprising a squeezable nut butter having
(a) at least 60% of its particles having its largest diameter of from 14-17 microns,
(b) at least one of:
(i) yield stress from 1026 to 7250 dynes/cm²,
(ii) squeeze force from 1.94 to 3.1 kg, all measured at 25° C.,
(c) a stabilizer level of from 0. 5 to 1.25 wt. %, and
(d) at least 90 wt. % nut materials, in combination with a further edible component.

5. The edible product according to claim 4 wherein said further edible component is selected from the group consisting of jelly, banana, and marshmallow filling.

6. The edible product according to claim 4 wherein said jelly includes a grape jelly or a strawberry jelly and said nut butter comprises peanut butter.

7. The edible product of claim 1 wherein the nut materials comprise peanut materials.

8. The edible product of claim 4 wherein the nut materials comprise peanut materials.

9. The edible product of claim 2 wherein the edible product comprises at least 90 wt. % peanut materials.

10. The edible product of claim 4 further exhibits a layer separation centrifuge rate from 0.305 g oil/hour to 0.04 g oil/hour, all measured at 25° C.

11. A combined package and edible product comprising:
a tube containing the edible product and having at one end thereof a cap including an applicator orifice for controlled dispensing of product, said edible product being squeezable.

12. The combined package and edible product of claim 11 wherein said edible product comprises a squeezable nut butter.

13. The combined package and edible product of claim 11 wherein said edible product comprises a mixture of nut butter and jelly.

14. The combined package and edible product of claim 13 wherein said nut butter comprises peanut butter.

15. The combined package and edible product of claim 11 wherein said edible food includes a nut butter which comprises
a) at least 60% of its particles having its largest diameter of from 14-17 microns,
b) a yield stress of from 1026 to 3996 at 25° C.,
c) a stabilizer level of from 0. 5 to 1.5 wt. %, and
d) at least 90 wt. % nut materials.

16. The combined package and edible product of claim 15 wherein said edible food includes a further edible component.

17. The combined package and edible product of claim 16 wherein said nut butter comprises peanut butter.

18. The combined package and edible product of claim 17 wherein said further edible component is selected from the group consisting of jelly, banana, and marshmallow filling.

19. The edible product according to claim 1 wherein said further edible component comprises 15-50 wt. % of the combined squeezable food and further edible component.

20. The combined package and edible product according to claim 11 wherein said orifice is in the shape of a running track.

21. The edible product according to claim 1 wherein said further edible component is selected from the group consisting of fillings and particulates.

22. The edible product according to claim 4 wherein said further edible component is selected from the group consisting of fillings and particulates.

23. The edible product according to claim 15 wherein said further edible component is selected from the group consisting of fillings and particulates
